(19) United States
(12) Patent Application Publication
(10) Pub. No.: US 2003/0182299 A1
(43) Pub. Date: Sep. 25, 2003

(54) Loaner inventory management system and method

(76) Inventor: John Burns, Burlington (CA)

Correspondence Address: HOFBAUER ASSOCIATES, SUITE 205 NORTH, 1455 LAKESHORE ROAD, BURLINGTON, ON, L7S 2J1, CA

(21) Appl. No.: 10/100,007

(22) Filed: Mar. 19, 2002

(51) Int. Cl. G06F 17/00

(52) U.S. Cl. 707/102

(57) ABSTRACT

An loaner inventory management system and method permits the tracking of loaned physical inventory items, such as medical instruments. Each set of items is housed in a container. Each item has its own place in the container and is in place upon delivery to a recipient. The system comprises a database having stored therein, in defined fields, information related to the sets of items. Database management software permits manipulation of the database and permits selection of one or more of the sets of items through accessing the fields of information related to the sets of items, and permits ordering of the selected sets of items for loan to a recipient for a period of time defined by delivery and due dates. The database management software permits printing out on paper hard copies of digital images representing the sets of items loaned out. Tamper evident material on each container indicates whether the container has been opened.

### FIELD OF THE INVENTION

The present invention relates to a loaner inventory management system and method, and more particularly to a loaner inventory management system and method for scheduling and tracking sets of physical inventory items being loaned out, and specifically to a loaner inventory management system and method for scheduling and tracking sets of medical instruments being loaned out to facilities such as hospitals for use in surgical procedures.

### BACKGROUND OF THE INVENTION

In business that rent or loan out inventory items such as instruments, tools, furniture, equipment, banquet supplies, and so on, it is common to keep such items in an inventory as itemized sets. It is necessary to both schedule and track the loaning of these sets of inventory items in order to ensure that proper and complete sets of inventory items are delivered to the appropriate recipient in a timely manner, and also to ensure that the proper and complete sets are returned to the loaner.

In modern hospitals, surgery is performed by medical professionals using medical instruments and implants that are organized into specific sets for each particular surgical procedure. Such sets of medical instruments typically contain about one hundred fifty instruments and surgical implants, such as, for example, hip joint implants, with the instruments being sized and otherwise adapted for specific use with the surgical implants contained within a particular set. In all, a set may contain as many as about seven hundred fifty instruments and implants.

In order to perform an operation, the required set of instruments and implants must arrive at the hospital complete one or two days before surgery, and every instrument must be in its place in a container. Also, these sets of medical instruments must be in a condition free form debris and contaminants and otherwise suitable for sterilization at the time of receipt by a hospital. Further, it is critical that such sets of medical instruments be available as necessary for an operation, and for all types of operations.

Carrying an inventory of all of the necessary sets of medical instruments and implants needed by a hospital is extremely expensive. Further, maintaining such sets of medical instruments and implants and ensuring that they are ready and available for surgery is logistically very difficult and demanding. Accordingly, hospitals tend to use medical equipment loaner service companies to provide sets of medical instruments and implants for medical operations on a short-term loaned out basis. The medical equipment loaner service company is responsible for delivering to hospitals, in a timely manner, sets of medical instruments and implants that are complete and correct, and free of debris and contaminants, with each instrument properly in its place in the appropriate container.

It is common for loaned sets of medical instruments and implants delivered to a hospital to be incomplete, to have instruments and implants improperly located, and to include the wrong instruments and implants. Such situations are never acceptable, and in some cases can endanger the life of a patient. However, it is very difficult even for trained medical loaner department staff who assemble the sets of medical instruments and implants to ensure that each set of medical instruments and implants and implants is complete and correct. It is also very difficult for trained medical professionals who are preparing for an operation to know whether the loaned out set of medical instruments and implants is the correct set, and whether the set of medical instruments and implants is complete and correct.

Also, it is common for sets of medical instruments and implants be returned to the medical instrument loaner service company past the due date. Overdue sets of medical instruments and implants pose a significant problem, since the overdue set might be booked by another hospital for use immediately after its return to the medical instrument loaner service company.

It is an object of the present invention to provide a loaner inventory management system and method that significantly reduces the chance of loaning out sets of physical inventory items that are incomplete, have items improperly located, and include wrong items.

It is an object of the present invention to provide a loaner inventory management system and method that significantly reduces the chance of loaning out sets of medical instruments and implants that are incomplete, have instruments and implants improperly located, and include wrong instruments and implants.

It is another object of the present invention to provide a loaner inventory management system and method that ensures that a loaned out set of medical instruments and implants is free from debris and contaminants at the time of a medical operation.

It is a further object of the present invention to provide a loaner inventory management system and method that promotes the timely return of loaned sets of physical inventory items.

It is a further object of the present invention to provide an instrument inventory management system and method that promotes the timely return of loaned sets of medical instruments and implants.

### SUMMARY OF THE INVENTION

In accordance with one aspect of the present invention there is disclosed a novel loaner inventory management system for permitting the scheduling and tracking of sets of physical inventory items on loan to a recipient. Each set of physical inventory items is housed in at least one container and each physical inventory item of each set has its own place in the at least one container, and is in place upon delivery to the recipient. The system comprises a database having stored therein, in defined fields, information related to the sets of physical inventory items, the defined fields including at least one field representing a unique identifier for each one of the sets of physical inventory items, a field for showing at least one digital image representing at least one picture of each one of the sets of physical inventory items, with the at least one container showing the physical inventory items in their proper place in the at least one container, a field for indicating the physical location of each set of physical inventory items on loan, and a field for indicating the name of each physical inventory item in each one of the sets of physical inventory items. There is database management software for manipulating the database. The database management software permits selection of one or more of the sets of physical inventory items through accessing the fields of information related to the sets of physical inventory items. The database management software also permits booking of one or more of the selected sets of physical inventory items for subsequently loaning out to a recipient for a period of time defined by a delivery date and a due date. The database management software also permits printing out on paper a hard copy of the at least one digital image for each of the one or more selected sets of physical inventory items being loaned out to a recipient.

In accordance with another aspect of the present invention there is disclosed a novel physical inventory item loaner system comprising sets of physical inventory items for loaning to a recipient. Each set of physical inventory items is housed in at least one container and each physical inventory items of each set has its own place in the at least one container and is in the place upon delivery to the recipient. Each container has an open in-use configuration and a closed configuration. A loaner inventory management system is provided for permitting the scheduling and tracking of the sets of physical inventory items on loan to a recipient and including a database having stored therein, in defined fields, information related to the sets of physical inventory items, and database management software for manipulating the database. The database management software permits selection of one or more of the sets of physical inventory items through accessing the information related to the sets of physical inventory items in the defined fields. The database management software also permits scheduling of the selected sets of physical inventory items for loan to a recipient for a period of time defined by a delivery date and a due date. There are tamper evident means operatively mounted on each the at least one container in the closed configuration, for providing indication of whether each the at least one container has been in the open configuration subsequent to the operative mounting of the tamper evident means.

In accordance with yet another aspect of the present invention there is disclosed a novel method of scheduling and tracking sets of physical inventory items on loan to a recipient, with each the set of physical inventory items being housed in at least one container and with each physical inventory item of each set having its own place in the container and being in the place upon delivery to the recipient. The method comprising the steps of: (a) taking a picture of each of the sets of physical inventory items in the at least one container; (b) storing in a database information related to each of the sets of physical inventory items, including a digital image representing each the picture; (c) receiving requests for loaning of the sets of physical inventory items; (d) printing out on paper a hard copy of the at least one digital image for each of the sets of physical inventory items to be loaned out; and, (e) loaning out to a recipient for a period of time defined by a delivery date and a due date, a set of physical inventory items and the hard copy of the at least one digital image corresponding to the set of physical inventory items being loaned out.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described herein below.

### BRIEF DESCRIPTION OF THE DRAWINGS

The novel features which are believed to be characteristic of the loaner inventory management system and method according to the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only, and are not intended as a definition of the limits of the invention. In the accompanying drawings:

FIG. 1 is a pictorial representation of a preferred embodiment of the loaner inventory management system according to the present invention;

FIG. 2 is a top plan view, partially cut away, of a set of physical inventory items, specifically a set of medical instruments and implants used to perform a surgical procedure and disposed within trays within a container;

FIG. 3A is a computer screen printout of the database software of the loaner inventory management system of FIG. 1;

FIG. 3B is a printout of the list of contents of the set shown in FIG. 2, generated by the software of the loaner inventory management system of FIG. 1, as seen in FIG. 3A;

FIG. 3C is a computer screen printout similar to FIG. 3A, but of an alternative embodiment loaner inventory management system;

FIG. 4 is a diagrammatic representation of a hard copy of a digital image in the database of FIG. 3;

FIG. 5A is a printout of a packing slip that is automatically generated at the time of shipping by the software of the loaner inventory management system of FIG.

FIG. 5B is a printout of a detailed list of the contents of the set of physical inventory items in a shipment set forth in the packing slip shown in FIG. 5A;

FIG. 6 is a printout of a detailed list of the contents of the set of physical inventory items in a shipment, but showing alternative types of physical inventory items than are shown in FIG. 5B;

FIG. 7A is a computer screen printout of the software of the loaner inventory management system of FIG. 1, showing a first screen wherein one or more sets of physical inventory items are being booked;

FIG. 7B is a computer screen printout of the software of the loaner inventory management system of FIG. 1, showing a second screen wherein one or more sets of physical inventory items are being booked;

FIG. 8 is a side elevational pictorial representation of a set of physical inventory items being photographed by a digital camera;

FIG. 9 is a computer screen printout of the database software of the loaner inventory management system of FIG. 1, showing a set of physical inventory items being entered into the database as being loaned out and ready to ship;

FIG. 10A is a computer screen printout of the database software of the loaner inventory management system of FIG. 1, but showing a set of physical inventory items being entered into the database as being returned;

FIG. 10B is a computer screen printout similar to FIG. 10A, additionally showing a list of the physical inventory items in the set;

FIG. 11 is a hard copy printout showing a list of sets of physical inventory items being automatically indicated as overdue;

FIG. 12 is a computer screen printout of a customer record of the database software of the loaner inventory management system of FIG. 1, showing the setting up of automatic notification checkpoints within a customer record; and

FIG. 13 is a pictorial representation similar to FIG. 1, additionally showing an overdue notification being sent to a recipient by e-mail.

### DETAILED DESCRIPTION OF A PREFERRED EMBODIMENT

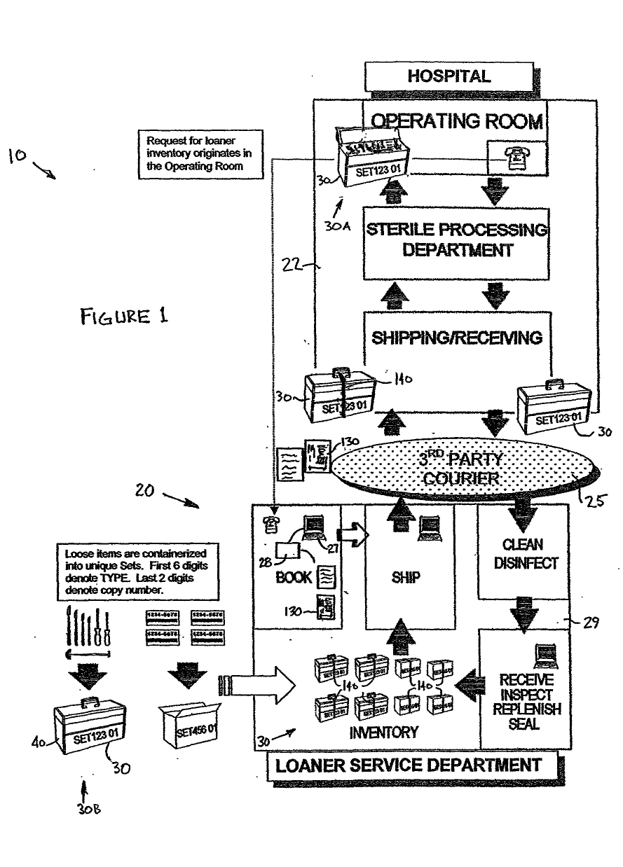

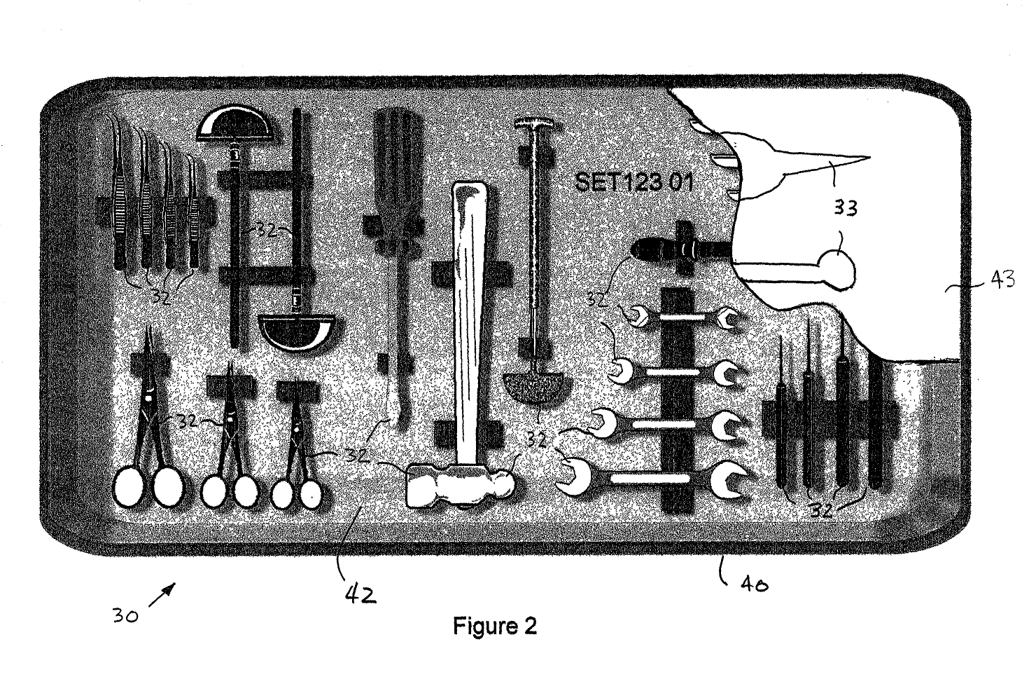

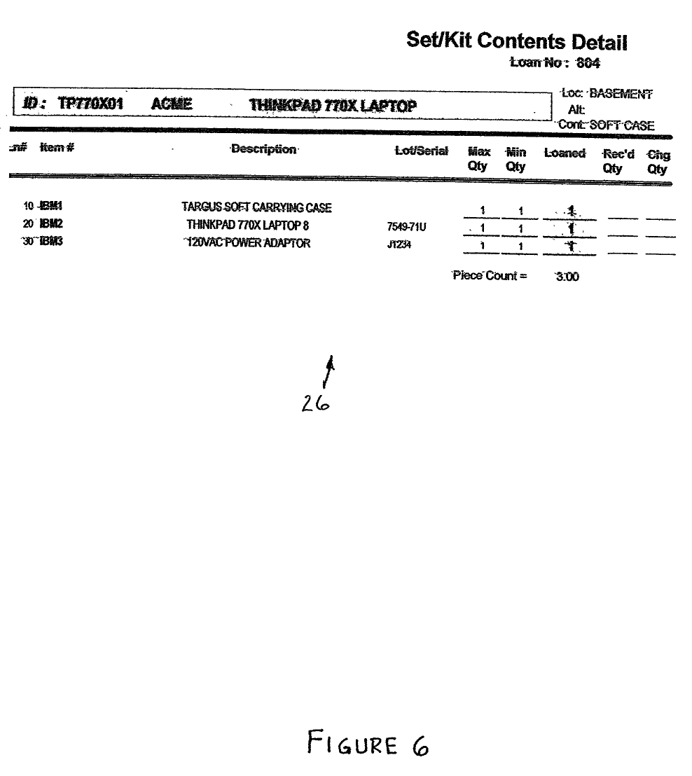

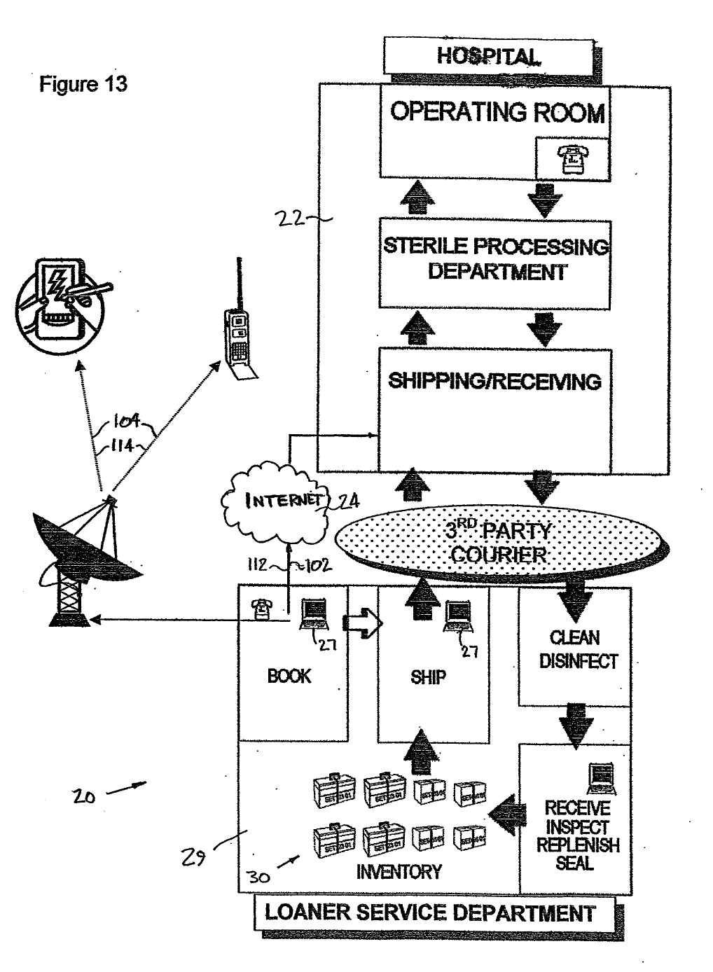

Reference will now be made to FIGS. 1 through 13, which show a preferred embodiment of the loaner inventory management system of the present invention, as indicated by general reference numeral 20. The loaner inventory management system 20 is for permitting the scheduling and tracking of sets 30 of physical inventory items on loan to a recipient 22. In the preferred embodiment as illustrated in FIGS. 1 through 13, the physical inventory items in the sets 30 of physical inventory items comprise medical instruments 32 and medical implants 33, as can be best seen in FIG. 2. The sets 30 of medical instruments 32 and medical implants 33 are owned and loaned out by a loaner service department of a company 29, as indicated in FIGS. 1 and 13, who also operate the loaner inventory management system 20.

Each set 30 of physical inventory items is housed in at least one container 40, depending on the number of medical instruments and medical implants 33 to be housed. As shown in FIG. 2, the medical instruments 32 and medical implants 33 are housed in one container 40 only. Each container 40 illustrated has a plurality of vertically stacked trays 42 contained therein, with a first top tray 42 and a lower second tray 43 each partially shown in cutaways in FIG. 2. Each medical instrument 32 and medical implant 33 of each set 30 of medical instruments 32 and medical implants 33 has its own place in the container 40, or containers 40, as the case may be, and each medical instrument 32 and medical implant 33 is in its place upon delivery to the recipient 22. As can be seen in FIG. 1, the container 40 has an open in-use configuration (indicated by general reference numeral 30A) that is typically adopted during use and during the placing of the medical instruments 32 and medical implants 33 into the container 40 and subsequently removing them from the container 40, and a closed configuration (indicated by general reference numeral 30B) that is typically used during shipping and storage of the of sets 30 of medical instruments 32 and medical implants 33.

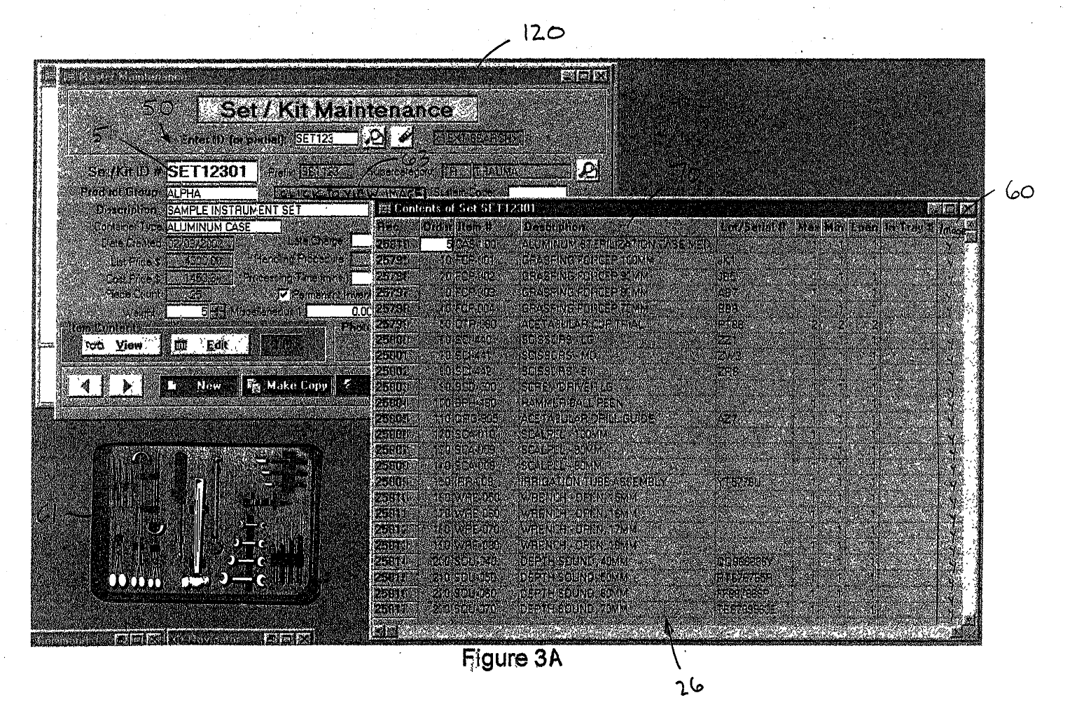

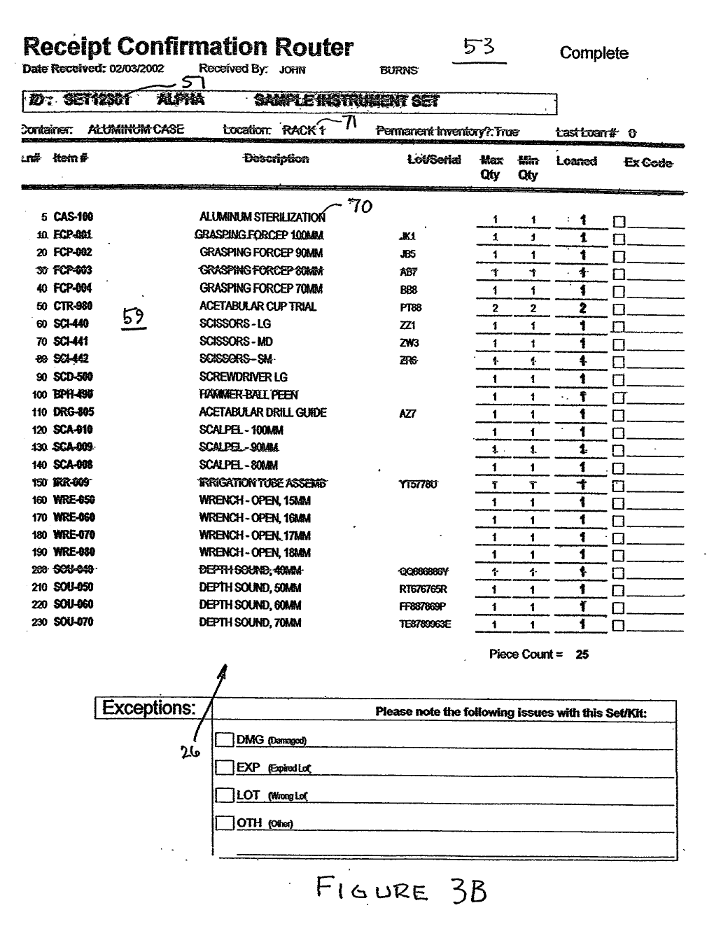

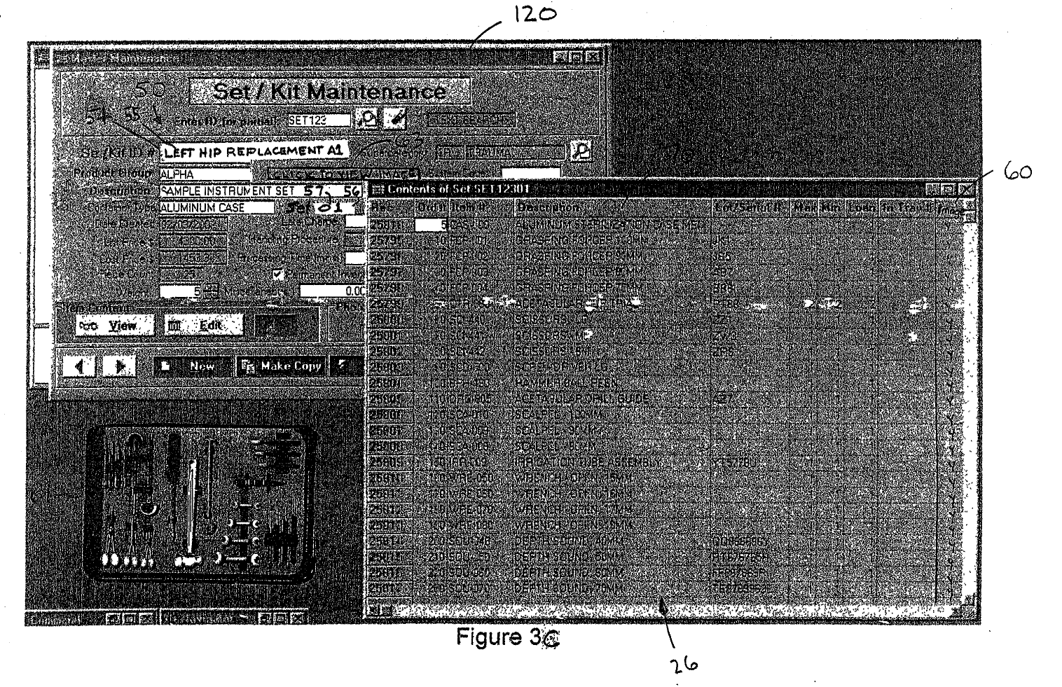

The loaner inventory management system 20 comprises a database, as indicated by general reference numeral 26 in FIGS. 3A, 3B, 5B, 6, and 10B, stored on a conventional computer, typically a microcomputer 27, as is best seen in FIGS. 1 and 13. The database 26 has stored therein, in defined fields, information related to the sets 30 of physical inventory items, whether they be medical instruments 32 and medical implants 33, as illustrated, or other types of physical inventory items, such as computers, tools, industrial equipment, and so on. The loaner inventory management system 20 also comprises database management software 120 for manipulating the database 26, as will be discussed in greater detail subsequently.

As can be best seen in FIG. 3A, the defined fields include at least one field, as indicated by the general reference numeral 50, representing a unique identifier 51 for each one of the sets 30 of physical inventory items, such as medical instruments 32 and medical implants 33. In the case of the medical instruments 32 and medical implants 33, as illustrated, the at least one field for representing a unique identifier 51 for each one of the sets 30 of physical inventory items comprises a single field that includes a unique alphanumeric code, specifically a unique serial number, for that set 30, as can be best seen in FIG. 3A. In the preferred embodiment illustrated, the unique serial number comprises eight digits. The first six digits (ie. SET 123) denote the type of set 30 of medical instruments 32 and medical implants 33, while the last two digits (01) denote the copy number (or set number) of the particular type of set 30. Other arrangements and permutations of numeric or alphanumeric characters are also possible and have utility.

Alternatively, as illustrated in FIG. 3C, the at least one field 50 representing a unique identifier for each one of the sets 30 of physical inventory items may comprise a first field 54 that includes a name 55 (left hip replacement A1) for each one of the plurality of the sets 30 of medical instruments 32 and medical implants 33, and a second field 56 that includes an alphanumeric code 57 (01), which is the set number. In combination, the name 55 and the alphanumeric code 57 are unique for each of the sets 30 of medical instruments 32 and medical implants 33.

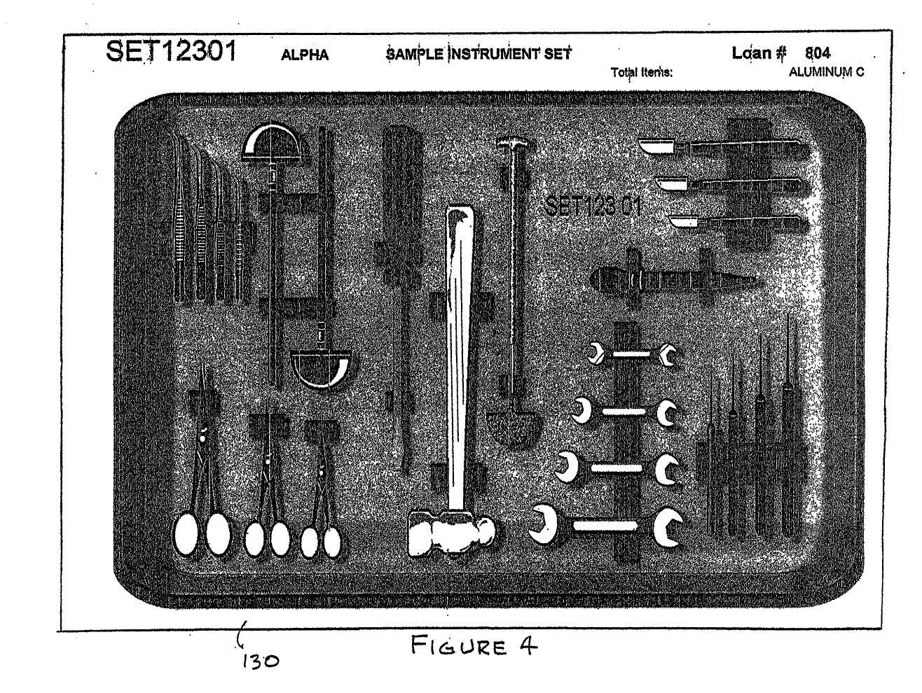

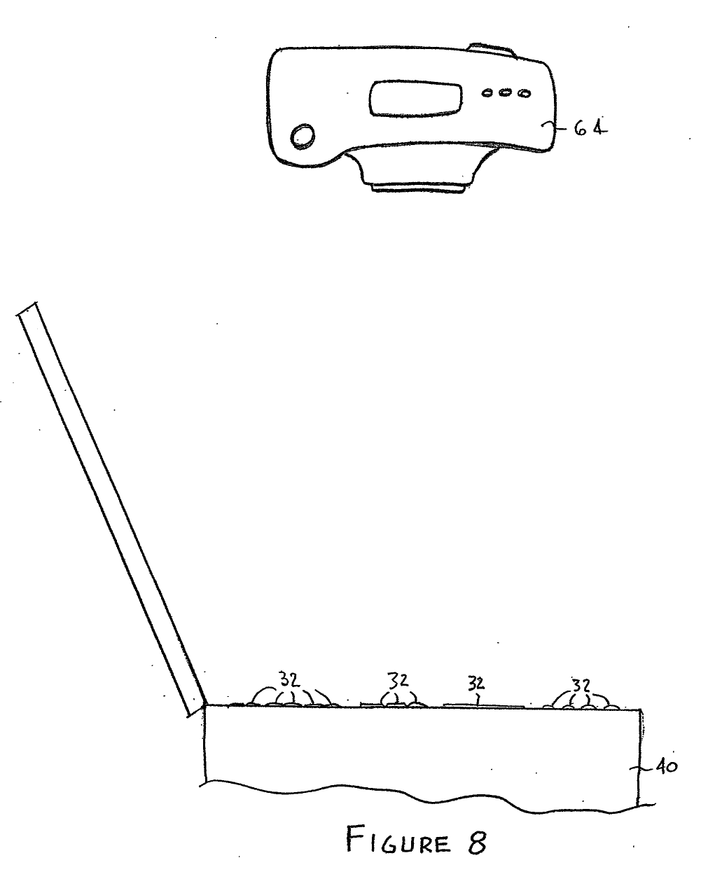

As can be best seen in FIG. 3A, there is also a field 60 in the database for showing at least one digital image 61, which digital image 61 represents at least one picture 62 of each one of the sets 30 of physical inventory items. As can be seen in FIG. 4, the digital image 61 represents a picture 62, as is best seen in FIG. 8, of one of the sets 30 of medical instruments 32 and medical implants 33, showing all of the medical instruments 32 and medical implants 33 in their proper place in the container 40. The digital image 61 can be viewed on a computer screen concurrently with the other database information by clicking on a button 63. As can be best seen in FIG. 8, a digital camera 64 is shown taking the picture 62 of the set 30 of medical instruments 32 and implants. Preferably, and in this case, the field for showing at least one digital image 61, as discussed, shows the medical instruments 32 and medical implants 33 in their proper place in the container 40 when the container 40 is in its open in-use configuration.

There is also provided a field 70 for indicating the name of each physical inventory item in each one of the sets 30 of medical instruments 32 and medical implants 33, as can be best seen in FIGS. 3A and 3B. This field 70 permits proper and accurate identification of all of the medical instruments 32 and medical implants 33 in the set 30. However, the order of the names in this field 70 need not co-relate to the order of the actual medical instruments 32 and medical implants 33 in their proper places within the container 40 although it can be so arranged.

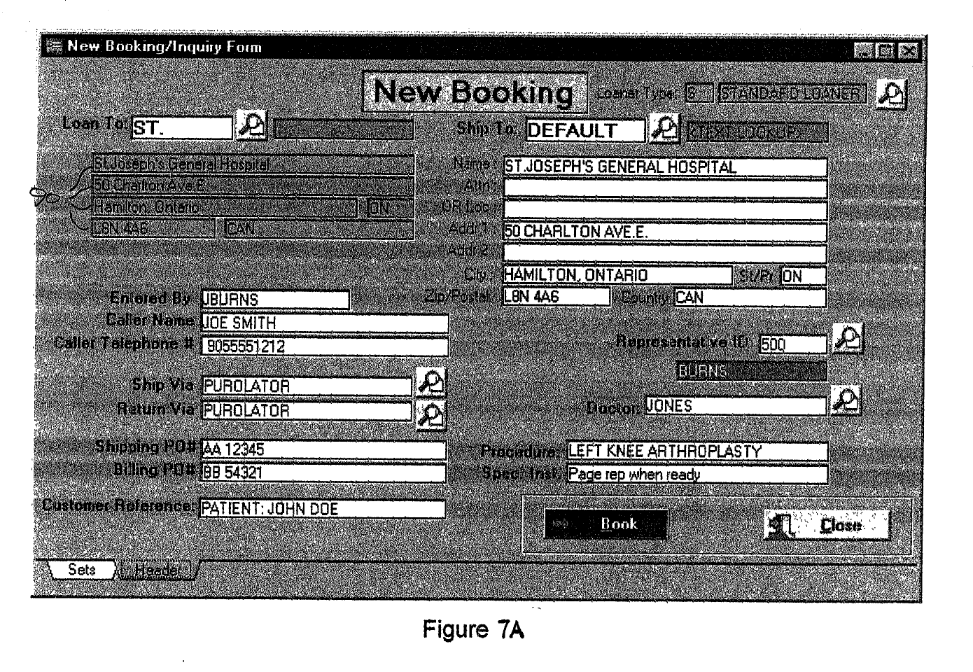

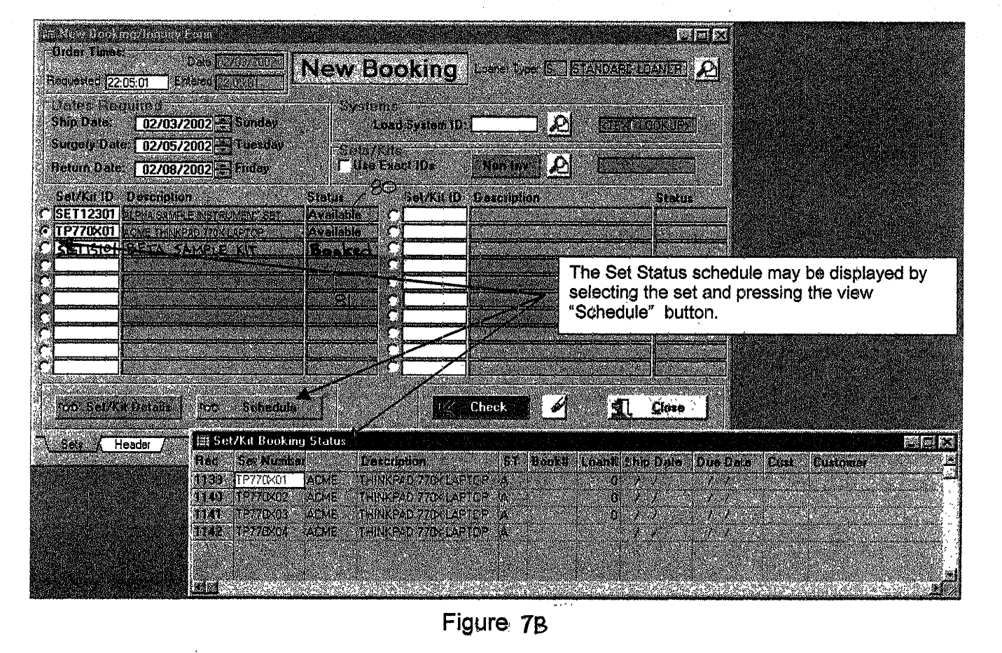

The database further comprises a field 80 for indicating which sets 30 of the medical instruments 32 and medical implants 33 are booked, as can be best seen in FIG. 7B. Such sets 30 of the medical instruments 32 and medical implants 33 are booked, as indicated by reference numeral 81, ahead of time for delivery to a specific facility on (or before) a certain due date. However, the sets 30 of the medical instruments 32 and medical implants 33 are not actually considered loaned out until they are shipped to the recipient 22. At that point, they are considered to be on loan to the recipient 22. Accordingly, there is a field 90 (actually several contiguous fields) for indicating the physical location of each set 30 of medical instruments 32 and medical implants 33 on loan, as can be best seen in FIG. 7A.

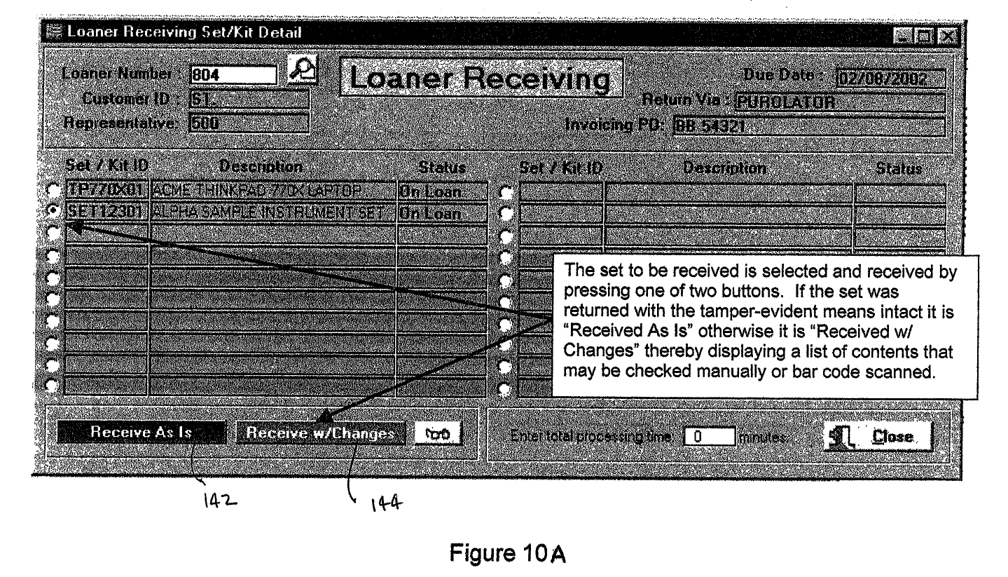

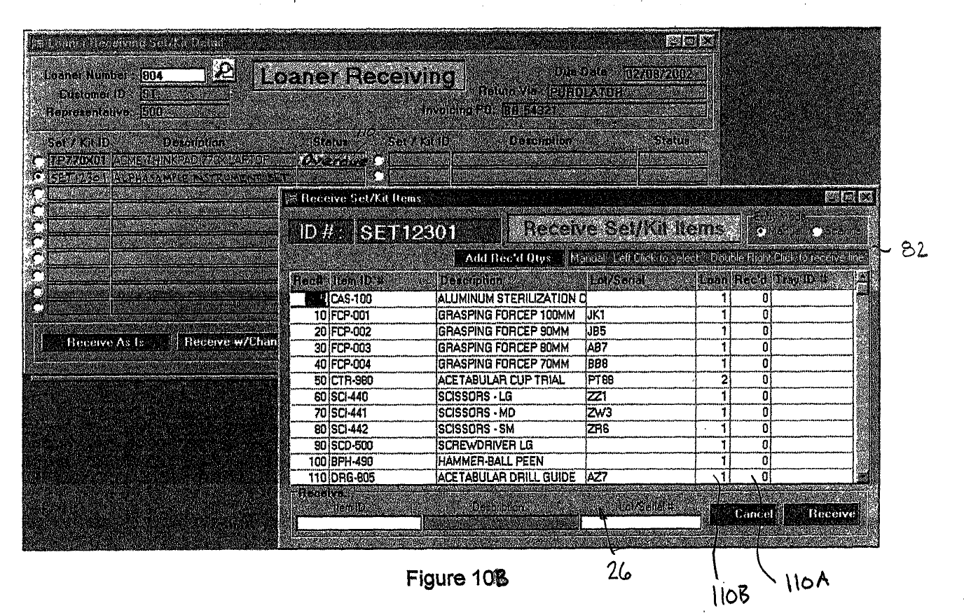

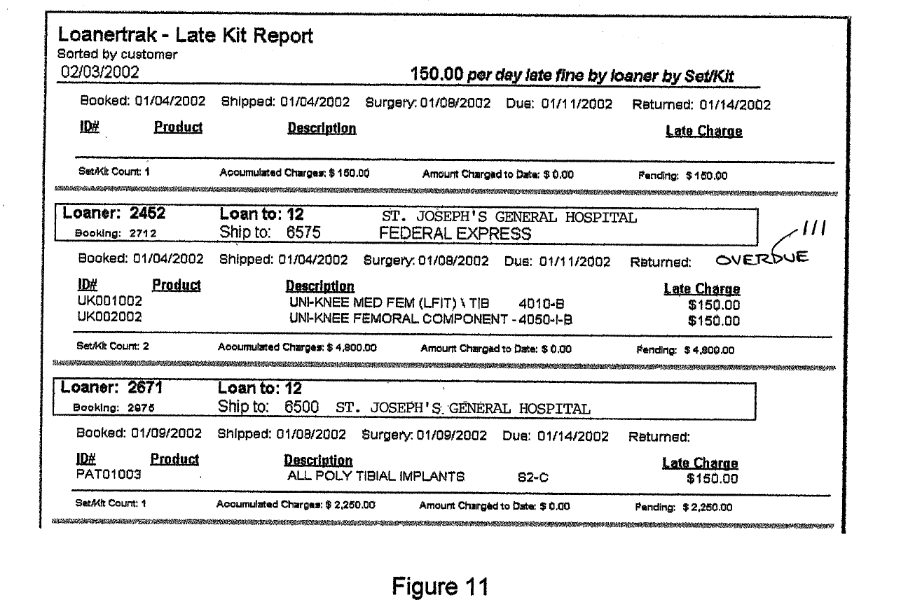

The database further comprises a field 110, as can be best seen in FIG. 10B, for indicating which sets 30 of booked medical instruments 32 and medical implants 33 that are loaned out, are overdue, based on the due date. The “Late Kit Report” shown in FIG. 11, also indicates that the set 30 of booked medical instruments 32 and medical implants 33 is overdue at 111. The database management software 120 automatically generates overdue reminders 102 (see FIG. 13) based on the field 100 for indicating which sets 30 of booked medical instruments 32 and medical implants 33 that are loaned out are overdue. Further, as can be best seen in FIG. 13, the database management software 120 automatically transmits the overdue reminders 102 via e-mail, to the particular recipient 22 who has been loaned the overdue sets 30 of medical instruments 32 and medical implants 33. The e-mail may be sent via the Internet 24. Additionally or alternatively, the database management software 120 may automatically transmit the overdue reminders via Wireless Application Protocol e-mail 104 to the particular recipient 22 who has been loaned the overdue sets 30 of medical instruments 32 and medical implants 33.

The database further comprises a series of fields 110A and 100B (see FIG. 10B) for indicating by comparison with one another that a set 30 of physical inventory items that has been returned is incomplete. In the event that a comparison of the fields 110A and 110B indicates that a set 30 of medical instruments 32 and medical implants 33 that has been returned is incomplete, as will be discussed in greater detail subsequently, the database management software 120 permits transmission of an appropriate e-mail message 112 (see FIG. 13) to the recipient 22 who returned the incomplete set 30. The e-mail transmission may be sent via the Internet 24 or via Wireless Application Protocol e-mail 114.

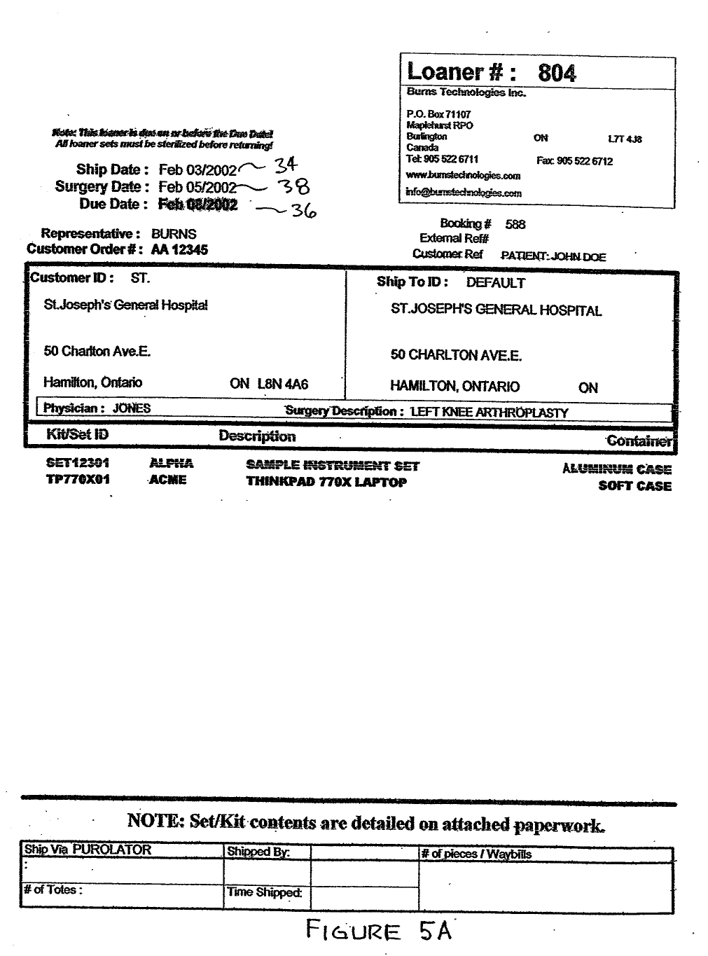

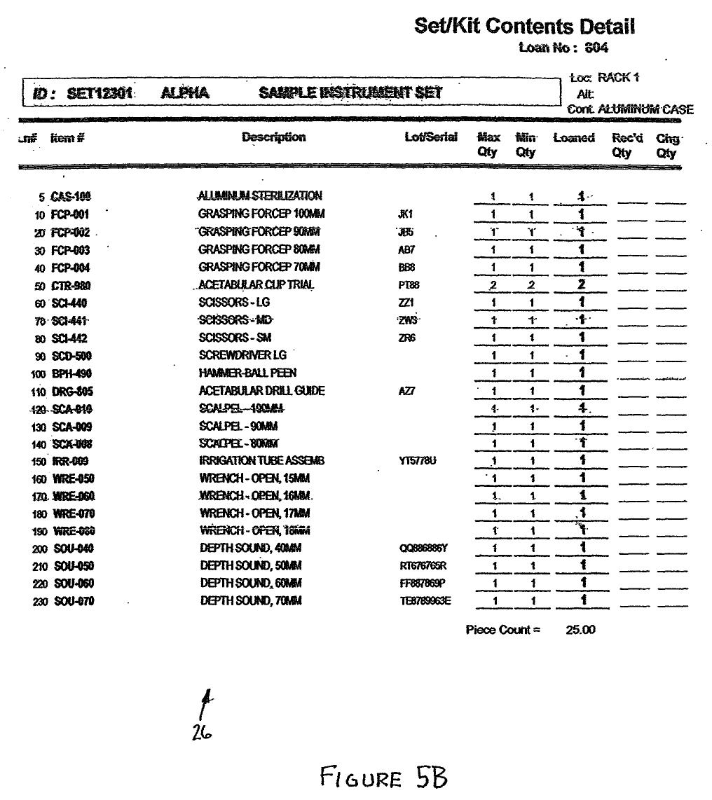

The database management software 120 permits selection of one or more of the sets 30 of medical instruments 32 and medical implants 33 through accessing the various fields of information related to the sets 30 of medical instruments 32 and medical implants 33, as can be best seen in FIG. 3A. The database management software 120 also permits booking of one or more of the selected sets 30 of medical instruments 32 and medical implants 33 for subsequently loaning out to a recipient 22, as can be seen in FIG. 7B. The loaning out is scheduled for a period of time defined by a delivery date 34 (also known as a ship date) and a due date 36, as can be best seen in FIG. 5A. As indicated in FIG. 1, shipping is done by courier 25. Accordingly, the selected sets 30 of medical instruments 32 and medical implants 33 would be delivered on the same day as they are shipped or on the next day, so as to be available ahead of the surgery date 38 (FIG. 5A).

The database management software 120 permits printing out on paper a hard copy 130, as can be best seen in FIG. 4, of the at least one digital image 61 for each of the one or more selected sets 30 of medical instruments 32 and medical implants 33 being loaned out to a recipient 22. The paper hard copy 130 of the at least one digital image 61 is shipped with the replicate set 30 and assists the recipient 22 in correctly identifying each one of the medical instruments 32 and medical implants 33 contained within the set 30, and also in determining that each one of the medical instruments 32 and medical implants 33 is in its proper place in the container 40. Failure to have the proper medical instruments 32 and medical implants 33 in their proper place in the container 40 is completely unacceptable when a medical procedure is about to be performed.

As can be best seen in FIG. 3B, the database management software 120 further permits printing out on paper of a hard copy 53 of the unique identifier 51 for each one of the sets 30 of medical instruments 32 and medical implants 33, thus allowing the printed hard copies that accompany a set 30 of medical instruments 32 and medical implants 33 to be properly matched to that set 30. The database management software 120 further permits printing out on paper a hard copy 59 (see FIG. 3B) of an ordered presentation of the names of each medical instrument 32 and medical implant 33 in each of the one or more selected sets 30 of medical instruments 32 and medical implants 33 being loaned out to a recipient 22. The ordered presentation preferably corresponds to the proper placement of the medical instruments 32 and medical implants 33 in the at least one container 40 in that the medical instruments 32 and implants 32 that are located in the first top tray 42 of the container (as illustrated by field 71), for instance, are preferably listed on a first sheet (shown in FIG. 3B), the medical instruments 32 and medical implants 33 that are located in the second lower tray are preferably listed next on a separate sheet (not shown), and so on.

It is also possible that the facility having the set 30 of medical instruments 32 and medical implants 33 may require the digital image 61 that represents a picture 62 of the medical instruments 32 and medical implants 33 to be in a alternative form, or may lose the paper hard copy 130, or for some reason may require another copy of the digital images 61 that represent the picture 62. In order that the facility can obtain a the digital image 61 in an alternative or additional form, the database management software 120 permits transmission of the digital images 61 to a recipient 22 of one or more of the at least one digital images 61 stored in the database. Such transmission would typically be made by means of the Internet 24, as indicated by reference numeral 65 in FIG. 13; however, other channels of transmission or also quite acceptable, such as via facsimile.

In another aspect, the present invention comprises a physical inventory item loaner system, as indicated by general reference numeral 10 (FIG. 1), or in other words a system for use in conjunction with loaning physical inventory items. The physical inventory item loaner system comprises sets 30 of physical inventory items for loaning to a recipient 22. In the preferred embodiment as illustrated in FIGS. 1 through 13, the physical inventory items in the sets 30 of physical inventory items comprise medical instruments 32 and medical implants 33, as can be best seen in FIG. 2.

Each set 30 of medical instruments 32 and medical implants 33 is housed in at least one container 40, depending on the number of medical instruments 32 and medical implants 33 to be housed. As shown in FIG. 2, the medical instruments 32 and medical implants 33 are housed in one container 40 only. Each medical instrument 32 and medical implant 33 of each set 30 has its own place in the container 40 and is in place upon delivery to the recipient 22. The container 40 has an open in-use configuration, as indicated by general reference numeral 30A in FIG. 1, and a closed configuration, as indicated by general reference numeral 30B in FIG. 1.

The loaner inventory management system 20, as described above, is part of the physical inventory item loaner system 10. The loaner inventory management system 20 is for permitting the scheduling and tracking of the sets 30 of physical inventory items, such as medical instruments 32 and medical implants 33, on loan to a recipient 22. The loaner inventory management system 20 includes a database having stored therein, in defined fields, information related to the sets 30 of medical instruments 32 and medical implants 33, and database management software 120 for manipulating the database.

The database management software 120 permits selection of one or more of the sets 30 of medical instruments 32 and medical implants 33 through accessing the information related to the sets 30 of medical instruments 32 and medical implants 33 in the defined fields. The database management software 120 permits scheduling of the selected sets 30 of medical instruments 32 and medical implants 33 for loan to a recipient 22 for a period of time defined by a delivery date 34 (also known as a ship date) and a due date 36, as can be best seen in FIG. 5A. As indicated in FIG. 1, shipping is done by courier. Accordingly, the selected sets 30 of medical instruments 32 and medical implants 33 would be delivered on the same day as they are shipped or on the next day, so as to be available ahead of the surgery date 38.

A tamper evident means 140 is operatively mounted on each container 40, with the container 40 being in the closed configuration, for providing indication of whether each the at least one container 40 has been in the open configuration subsequent to the operative mounting of the tamper evident means 140. In the preferred embodiment illustrated, the tamper evident means comprises a tamper evident material, such as polypropylene. As is best seen in FIG. 1, the tamper evident means comprises a polypropylene band 140 snugly encircling the container 40. In order to gain access to the medical instruments 32 and medical implants 33 in the container 40, the container 40 must be manipulated from its closed configuration 30B to its open configuration 30A. Such manipulation of the container 40 would cause obvious deformation or breach of the polypropylene band 140.

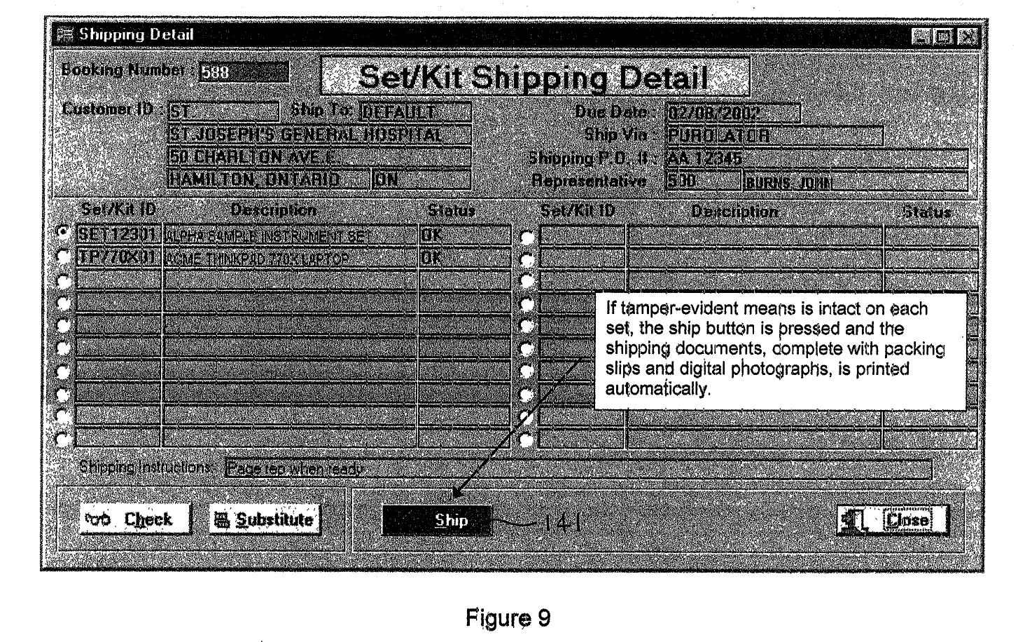

At the time of shipment, the sets 30 of medical instruments 32 and medical implants 33 are checked to ensure that the polypropylene band 140 is intact. If the polypropylene band 140 is intact, the “Ship” button 141 (see FIG. 9) is clicked on. Any packing slips (not shown), paper hard copies 130 of the digital images 61, and paper hard copies 59 of an ordered presentation of the names of each medical instrument 32 and medical implant 33 are all printed automatically for shipment with the sets 30.

In the event that the container 40 was received by a recipient 22 with the polypropylene band 140 deformed, the recipient 22 would know that the container 40 had been opened or otherwise tampered with since it was initially closed and sealed for delivery.

Further, when the set 30 of medical instruments 32 and medical implants 33 is returned to the loaner service department of a company 29, the set 30 is examined to determine whether the tamper evident material (polypropylene band 140) is intact or not. If the polypropylene band 140 is intact, this is entered into the database (see FIG. 10A) by clicking the “Received As Is” button 142. The status of the kit 30 returns to “available”, as indicated by reference numeral 80A in FIG. 7B. If the set 30 is returned with the polypropylene band 140 not intact, this is entered into the database (see FIG. 10) by clicking the “Received with Changes” button. As can be seen in FIG. 10B, a pop-up window 82 appears over the computer screen shown in FIG. 10A. The pop-up window 82 displays the names and item numbers of particular medical instruments 32 and medical implants 33 in the set 30. By clicking on the appropriate field and record for each medical instrument 32 or medical implant 33, and then clicking on the “Received” button 146, the fact that the particular medical instrument 32 or medical implant 33 has been returned is entered into the field 110A. The entries in field 148 are compared to field 110B (the quantity of medical instruments 32 or medical implants 33 loaned out) and any non-consumable items, such as medical instruments 32, that are missing must be accounted for. Typically, the recipient 22 who has returned the set 30, is notified by means of e-mail 112,114 of the missing items. Once the missing items have been returned, by the recipient 22, or have been replaced from stock, and the set 30 is therefore considered complete, the computer screen as shown in FIG. 10A is brought up on the computer screen and the “Received As Is” button 142 is clicked on to return the status of the set 30 to “available”, as indicated by reference numeral 80A in FIG. 7B.

In yet another aspect, the present invention comprises a method of scheduling and tracking sets 30 of physical inventory items on loan to a recipient 22. In the preferred embodiment as illustrated in FIGS. 1 through 13, the physical inventory items in the sets 30 of physical inventory items comprise medical instruments 32 and medical implants 33, as can be best seen in FIG. 2. Each set 30 of medical instruments 32 and medical implants 33 is housed in at least one container 40, depending on the number of medical instruments 32 and medical implants 33 to be housed. As shown in FIG. 2, the medical instruments 32 and medical implants 33 are housed in one container 40 only. Each medical instrument 32 and medical implant 33 of each set 30 has its own place in the container 40 and is in the place upon delivery to the recipient 22.

The method comprises the steps of (a) taking a picture 62 of each of the sets 30 of medical instruments 32 and medical implants 33 in the container 40, as can be best seen in FIG. 7; (b) storing in a database information related to each of the sets 30 of medical instruments 32 and medical implants 33, including a digital image 61 representing each picture 62 taken in step (a); (c) receiving requests for loaning of the sets 30 of medical instruments 32 and medical implants 33, as is best seen in FIG. 1; (d) printing out on paper a hard copy 130, as is best seen in FIG. 1, of the at least one digital image 61 for each of the sets 30 of medical instruments 32 and medical implants 33 to be loaned out; and, (e) loaning out to a recipient 22 for a period of time defined by a delivery date and a due date, a set 30 of medical instruments 32 and medical implants 33 and the hard copy 130 of the at least one digital image 61 corresponding to the set 30 of medical instruments 32 and medical implants 33 being loaned out.

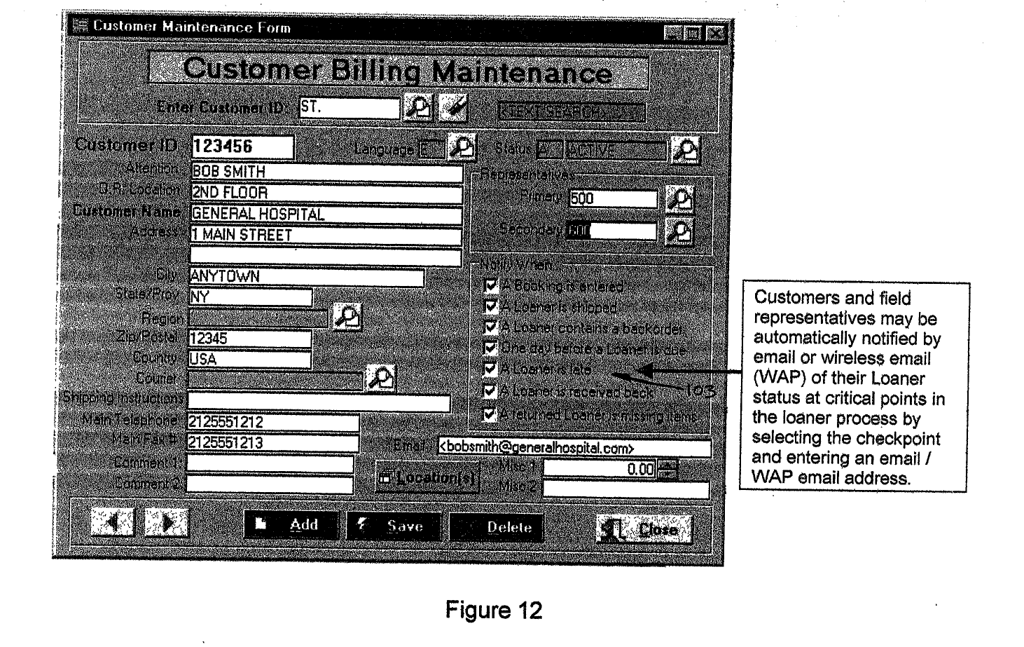

If necessary, overdue reminders 102 are automatically generated, as indicated by reference numeral 103 in FIG. 12 The overdue reminders 102 indicate which sets 30 of medical instruments 32 and medical implants 33 that are loaned out are overdue. If overdue reminders 102 are generated, as best seen in FIG. 13, the present method may further comprise the step of automatically transmitting the overdue reminders via e-mail to the particular recipient 22 who has been loaned the overdue set 30 of medical instruments 32 and medical implants 33. As can be best seen in FIG. 13, the e-mail overdue reminders may be transmitted over the Internet 24, or may be transmitted via Wireless Application Protocol 104.

As can be understood from the above description and from the accompanying drawings, the loaner inventory management system and method according to the present invention significantly reduces the chance of loaning out sets of physical inventory items, including medical instruments 32 and medical implants 33, that are incomplete, have items improperly located, and include wrong items, ensures that a loaned out set of medical instruments 32 and implants is free from debris and contaminants at the time of a medical operation, promotes the timely return of loaned sets of physical inventory items, including medical instruments 32 and medical implants 33, all of which features are unknown in the prior art.

Other variations of the above principles will be apparent to those who are knowledgeable in the field of the invention, and such variations are considered to be within the scope of the present invention. For instance, the loaning of other types physical inventory items can be scheduled and tracked, including, but not limited to computers, and computer equipment, audio video equipment, electronic gaming equipment, tools, industrial equipment, and so on. Further, other modifications and alterations may be used in the design and manufacture of the loaner inventory management system and method of the present invention without departing from the spirit and scope of the accompanying claims.

I claim:

1. A loaner inventory management system for permitting the scheduling and tracking of sets of physical inventory items on loan to a recipient, each said set of physical inventory items being housed in at least one container and each physical inventory item of each set having its own place in said at least one container and being in said place upon delivery to said recipient, said system comprising:
a database having stored therein, in defined fields, information related to said sets of physical inventory items, said defined fields including at least one field representing a unique identifier for each one of said sets of physical inventory items, a field for showing at least one digital image representing at least one picture of each one of said sets of physical inventory items, said at least one picture showing said physical inventory items in their proper place in said at least one container, a field for indicating the physical location of each set of physical inventory items on loan, and a field for indicating the name of each physical inventory item in each one of said sets of physical inventory items;
database management software for manipulating said database;
wherein said database management software permits selection of one or more of said sets of physical inventory items through accessing said fields of information related to said sets of physical inventory items, and said database management software permits booking of one or more of said selected sets of physical inventory items for subsequently loaning out to a recipient for a period of time defined by a delivery date and a due date; and,
wherein said database management software permits printing out on paper a hard copy of said at least one digital image for each of said one or more selected sets of physical inventory items being loaned out to a recipient.

2. The loaner inventory management system of claim 1, wherein said database management software further permits printing out on paper a hard copy of said unique identifier for each one of said sets of physical inventory items.

3. The loaner inventory management system of claim 2, wherein said database management software further permits printing out on paper a hard copy of an ordered presentation of said names of each physical inventory item in each of said one or more selected sets of physical inventory items being loaned out to a recipient, with said ordered presentation corresponding to said proper places of said physical inventory items in said at least one container.

4. The loaner inventory management system of claim 3, wherein said at least one field representing a unique identifier each one of said sets of physical inventory items comprises a first field that includes a name for each one of said plurality of said sets of physical inventory items, and a second field that includes an alphanumeric code, wherein, in combination, said name and said alphanumeric code are unique for each of said sets of physical inventory items.

5. The loaner inventory management system of claim 3, wherein said at least one field for representing a unique identifier each one of said sets of physical inventory items includes a unique alphanumeric code.

6. The loaner inventory management system of claim 4, wherein said database management software permits transmission to a recipient of one or more of said at least one digital images stored in said database.

7. The loaner inventory management system of claim 6, wherein said database further comprises a field for indicating which sets of said physical inventory items are booked.

8. The loaner inventory management system of claim 7, wherein said database further comprises a field for indicating which sets of booked physical inventory items that are loaned out, are overdue, based on said due date.

9. The loaner inventory management system of claim 8, wherein said database management software automatically generates overdue reminders based on said field for indicating which sets of booked physical inventory items that are loaned out are overdue.

10. The loaner inventory management system of claim 9, wherein said database management software automatically transmits said overdue reminders via e-mail to the particular recipient who has been loaned the overdue sets of physical inventory items.

11. The loaner inventory management system of claim 10, wherein said database management software automatically transmits said overdue reminders via Wireless Application Protocol e-mail to the particular recipient who has been loaned the overdue sets of physical inventory items.

12. The loaner inventory management system of claim 9, wherein said database further comprises a field for indicating that a set of physical inventory items that has been returned is incomplete.

13. The loaner inventory management system of claim 12, wherein, in the event that said field for indicating that a set of physical inventory items that has been returned is incomplete indicates that a set of physical inventory items has been returned incomplete, said database management software permits transmission of an e-mail message to the recipient who returned the incomplete set.

14. The loaner inventory management system of claim 1, wherein said physical inventory items in said sets of physical inventory items comprise medical instruments 32 and medical implants 33.

15. The loaner inventory management system of claim 14, wherein each said at least one container has an open in-use configuration and a closed configuration.

16. The loaner inventory management system of claim 15, wherein said field for showing at least one digital image representing at least one picture of each one of said sets of physical inventory items in said at least one container shows all physical inventory items in their proper place in said at least one container when said at least one container is in said open in-use configuration.

18. A physical inventory item loaner system comprising:
sets of physical inventory items for loaning to a recipient, wherein each said set of physical inventory items is housed in at least one container and each physical inventory items of each set has its own place in said at least one container and is in said place upon delivery to said recipient, and wherein each said at least one container has an open in-use configuration and a closed configuration;
a loaner inventory management system for permitting the scheduling and tracking of said sets of physical inventory items on loan to a recipient and including a database having stored therein, in defined fields, information related to said sets of physical inventory items, and database management software for manipulating said database;
wherein said database management software permits selection of one or more of said sets of physical inventory items through accessing said information related to said sets of physical inventory items in said defined fields, and said database management software permits scheduling of the selected sets of physical inventory items for loan to a recipient for a period of time defined by a delivery date and a due date; and
tamper evident means operatively mounted on each said at least one container in said closed configuration, for providing indication of whether each said at least one container has been in said open configuration subsequent to the operative mounting of said tamper evident means.

19. The loaner system of claim 18, wherein said tamper evident means comprises a tamper evident material.

20. The loaner system of claim 19, wherein said tamper evident material comprises a polypropylene band.

21. A method of scheduling and tracking sets of physical inventory items on loan to a recipient, each said set of physical inventory items being housed in at least one container and each physical inventory items of each set having its own place in said container and being in said place upon delivery to said recipient, said method comprising the steps of:
(a) taking a picture of each of said sets of physical inventory items in said at least one container;
(b) storing in a database information related to each of said sets of physical inventory items, including a digital image representing each said picture;
(c) receiving requests for loaning of said sets of physical inventory items;
(d) printing out on paper a hard copy of said at least one digital image for each of said sets of physical inventory items to be loaned out; and,
(e) loaning out to a recipient for a period of time defined by a delivery date and a due date, a set of physical inventory items and said hard copy of said at least one digital image corresponding to the set of physical inventory items being loaned out.

22. The method of claim 21, further comprising the step of automatically generating overdue reminders indicating which sets of physical inventory items that are loaned out are overdue.

23. The method of claim 22, further comprising the step of automatically transmitting said overdue reminders via e-mail to the particular recipient who has been loaned the overdue set of physical inventory items.

24. The method of claim 23, further comprising the step of automatically transmitting said overdue reminders via Wireless Application Protocol e-mail to the particular recipient who has been loaned the overdue set of physical inventory items.

25. The method of claim 21, wherein said physical inventory items in said sets of physical inventory items comprise medical instruments 32 and medical implants 33.
